(19) United States
(12) Patent Application Publication
(10) Pub. No.: US 2005/0212715 A1
(43) Pub. Date: Sep. 29, 2005

(54) User terminal with expandable reflector used for satellite reception during inclement weather

(76) Inventor: Oliver W. Saunders, Los Angeles, CA (US)

Correspondence Address: Donald W. Meeker;Patent Agent, 924 East Ocean Front #E, Newport Beach, CA, 92661, US

(21) Appl. No.: 10/807,804

(22) Filed: Mar. 23, 2004

(51) Int. Cl. H01Q 15/20

(52) U.S. Cl. 343/915

(57) ABSTRACT

A set of reflector extensions extends and retracts around a reflector in response to a signal quality sensor signal to a programmed control. A degraded satellite signal detected by the sensor activates a deployment mechanism to extend the reflector extensions to extend a surface contour of the reflector to modify its gain performance.

### BACKGROUND OF THE INVENTION

1. Field of the Invention

The present invention relates to user terminals for reception of broadband or multi-media satellite signals, and particularly to a user terminal having a central reflector with expandable extensions, which may be extended for better reception during precipitation and retracted during fair weather for a smaller, more aesthetically pleasing reflector.

2. Description of the Prior Art

Operators of broadband and multi-media satellite systems have determined that terminal size is a major discriminator in attracting new customers. For reasons of aesthetics, customer preference is to install the smallest possible size terminal.

The frequencies allocated for these services exhibit significant signal attenuation during precipitation (i.e., rain fade). The use of small terminals significantly limits the capacity of their associated satellite transmission systems because of a significant amount of link margin, currently in the form of excess RF power and/or additional ECC parity information, is needed to achieve acceptable levels of link availibility.

Numerous schemes exist for deployable antennas which are stored in a compact form for transport, etc., can be quickly assembled into their operational configuration and, if necessary, can be returned to their transportable state.

End users have used covers or shields to protect the satellite signal from precipitation, but these are not aesthetically pleasing. But, none of the prior art patents provide an effective solution for expanding the reception capacity of a user antenna during inclement weather.

U.S. Pat. No. 4,529,277, issued Jul. 16, 1985 to Gee, describes a solid surface foldable reflector for being stowed in a constrained volume on a spacecraft comprises a central portion with a series of peripheral elements hingedly attached around the periphery thereof for folding movement about axes tangential to a circle centered on the center of the reflector. Those elements referenced have axes spaced radially further from the center of the reflector than the axes of elements so that from a stowed condition with all the elements overlying central portion, firstly elements may be unfolded and then elements may be unfolded, without fouling, to define a rigid, generally smooth reflector surface wherein the gaps between adjacent elements are not significant.

U.S. Pat. No. 4,761,655, issued Aug. 2, 1988 to Butcher, describes a transportable antenna for an earth station. The antenna (e.g., a transportable, lightweight and cheap antenna for temporary earth stations) is constructed out of three components. The center component is a circular/parabolic dish. The side components extend the dish to give the composite a major diameter and a minor diameter. In use the antenna is aligned so that the major diameter is aligned with the direction of the geostationary arc.

U.S. Pat. No. 6,215,453, issued Apr. 10, 2001 and U.S. Pat. No. 6,331,839, issued Dec. 18, 2001, both to Grenell, provides a satellite antenna enhancer and method and system for using an existing satellite dish for aiming replacement dish. An easily installable signal enhancement addition for a satellite dish, and method for using an installed dish as a reference is provided that allows installation of the enhancement without re-acquiring the satellite signal or re-aiming the dish. In one variation, the enhancement includes a reflector addition fitted with fasteners that locate the reflector against the existing dish, and use of the original feed horn, which is relocated using a support extension. This variation avoids the “shadow” of the feed horn and its support arm, and minimizes the reflective surface area at the lower end of the dish, which reduces collection of such interfering material as snow, rain, and debris. In variations using increased reflector size, the enhancement reduces loss of signal during inclement weather or in other situations in which the satellite signal is partially blocked. In one variation, the added reflector is a standard parabolic reflector superimposed over the original reflector, or replacing it on its mount. In a second variation, the added reflector is custom designed to extend the existing dish surface only at the original reflector's upper edge. In a third variation, the added reflector is ring-shaped and attached at the outer edge of the original reflector. Also disclosed is a method and system for installing an enhanced dish using an installed dish as a reference, the enhanced dish receiving signals from multiple satellites simultaneously, and adjustment of offset occurring using the aiming point of the original dish and a lookup table for the geographical location of installation.

U.S. Pat. No. D400,888, issued Nov. 10, 1998 to Schutzius, claims the ornamental design for a satellite dish signal protector, in which the dish has a brim projecting forwardly thereof.

U.S. Pat. No. 5,797,082, issued Aug. 18, 1998, U.S. Pat. No. 5,913,151, issued Jun. 15, 1999, and U.S. Pat. No. 6,075,969, issued Jun. 13, 2000, all to Lusignan, disclose a method and receiver for receiving signals from a constellation of satellites in close geosynchronous orbit. A C-Band or Ku-Band satellite communication system uses a relatively small receiving antenna while operating within current FCC designated bandwidth and using existing satellite configurations. Aperture synthesis techniques create nulls in orbit locations from which potential interference is expected. Bandwidth inefficient modulation techniques reduce transmission power flux density. Video compression reduces the power necessary to transmit video information. These three features make possible a receiving antenna with a receiving area equivalent to that of a three foot diameter dish, at C-Band frequencies. Comparable reductions are possible for Ku-, Ka-, S- and L-Band systems: Compressing the data reduces the required transmitted power by a factor of ten. Spreading the bandwidth reduces the power density below the FCC limitation. However, reducing the antenna diameter increases the beam width of the antenna, hence, the smaller antenna can no longer discriminate between adjacent C-Band satellites in their current orbital configuration. By designing the receiving antenna with nulls in orbital locations where potentially interfering satellites would be located, the small antenna avoids this interference. The same general technique is possible for a Ku-Band Antenna system. The FCC power limits are higher at Ku-Band than C-Band, however, losses due to rain absorption and thermal noise are higher at Ku-Band frequencies. Nevertheless, equivalent size savings on Ku-Band antennas are possible with the combination of the above techniques, when tailored for the Ku-Band environment.

U.S. Pat. No. 5,334,990, issued Aug. 2, 1994 to Robinson, shows a compact, portable Ku-band satellite dish antenna system comprises a dish-shaped member having an inner surface that includes a central circular flat area and a plurality of annular parabolically-shaped segments concentric with the central circular flat area for providing a plurality of focal points over the inner surface of the dish-shaped member to thereby improve the signal gathering characteristics of the dish antenna system.

U.S. Pat. No. 5,877,730, issued Mar. 2, 1999 to Foster, shows a satellite dish with a shield. The satellite dish has a brim projecting forwardly thereof and from the sides and top portions of the dish to prevent snow and ice accumulation on the face of the dish, while providing minimal obstruction of a collected signal from a satellite and reflection of the collected signal to a horn feed of a television antenna system.

U.S. Pat. No. 6,191,753, issued Feb. 20, 2001 to Ellis, concerns systems and methods for covering antennas used in digital satellite communications systems. A rigid cover for satellite antennas prevents rain from passing between a dish member and a converter assembly of the satellite antenna. The cover may be designed for a particular style of satellite antenna or, preferably, have a mounting portion adapted to accommodate a plurality of styles of satellite antennas.

U.S. Pat. No. 5,815,125, issued Sep. 29, 1998 to Kelly, is for a satellite dish cover, especially suited for protecting a satellite dish assembly of standard construction, which includes a sheet of material constructed and arranged for being disposed over the dish and feeder horn of the satellite dish assembly. The sheet has a main body panel which wraps around the dish and feeder horn of the satellite dish assembly and a secondary body panel which extends from the dish to the support of the satellite dish assembly. The main body panel has an outer end portion for receiving the feeder horn therein. A cinching mechanism is affixed to the end portion for cinching and tightening the main body panel about the dish and feeder horn of the satellite dish assembly.

U.S. patent application No. 20030016634, published Jan. 23, 2003 by Freedman, illustrates multiple band load balancing satellite communication, in which the throughput between a satellite and a plurality of users is controlled by adjusting resources among the users depending on the signal degradation (such as rain fade) experienced by the users. A plurality of time division multiplex (TDM) channels (also called bands) each have a plurality of TDM subchannels corresponding to the users. The channels have different signal fade ranges and the users are assigned to channels based on their signal degradations. Users with signal degradations within a range of each other are assigned to different subchannels within a common channel. Those users with downlinks having substantial signal degradation are given a greater packet length or duration for the data packets of their corresponding subchannels. Additionally, the forward error correction (FEC) code rate is adjusted depending on signal degradation. If some downlinks are experiencing extreme signal degradation, their packet lengths can be reduced to zero and the length (i.e., time within the TDM frame) reallocated to other subchannels until conditions improve.

What is needed is a user terminal having a central reflector with expandable extensions, which may be extended for better reception during precipitation and retracted during fair weather for a smaller, more aesthetically pleasing reflector.

### SUMMARY OF THE INVENTION

An object of the present invention is to provide a user terminal having a central reflector with expandable extensions, which may be extended for better reception during precipitation and retracted during fair weather for a smaller, more aesthetically pleasing reflector.

In brief, a user terminal changes size (i.e., its effective capture area) and hence modifies its gain performance to accommodate changing operating conditions, such as during precipitation. Through any of several mechanisms (or combinations of them) the terminal senses the operating conditions on the link that it is supporting. During normal conditions, the terminal assumes its smallest size; when conditions degrade sufficiently, the size of the terminal's reflector is expanded in order to provide additional gain to mitigate a portion of the link's performance reduction.

Various thresholds, hysteresis and delays are employed to prevent the terminal from cycling between states during short intervals of change.

The keys to this concept are that the terminal expands only when 1.) the terminal is in use and 2.) the supported link is experiencing difficulty (usually during heavy precipitation when the appearance of the terminal is unlikely to be an issue). In a typical home user scenario, this may only amount to 20 hours per year (and half of these are likely to be at night).

The, major advantage of this invention is that is enables satellite system designers at Ku-band and above to move a portion of the responsibility for the system's link margin against rain fade to the user terminal while heeding the user community's (i.e. customer's) strong preference for the smallest possible terminal. This re-allocation of margin can be used to either: increase system capacity while maintaining the established link availability; improve the overall availability of an existing system without reducing its capacity; provide additional flexibility in the allocation of capacity and availability in new designs; and, for return links, reduce the required size of the user terminal's power amplifier. The additional system revenues achieved through improvements in system efficiency should greatly exceed the small additional “per terminal” cost of this enabling feature.

Another advantage of the present invention is that it adds another constituent piece to link margin by allowing the user's terminal to change its gain in order to adapt to its specific link transmission conditions and thereby removes a portion of the link margin burden from the transmitting end so that the freed-up margin can then be used to either increase system capacity or to improve system availability. In a typical scenario (DVB-S satellite video), the use of antennas that can change their gain by one dB (1 dB) in response to precipitation would increase the system's capacity by 11.1% without changing the established link availability.

Another advantage of the present invention is the ability to improve the profitability of existing satellite services to homes and small businesses since the additional link margins being carried to service fringe or disadvantaged customers can be converted to increased capacity.

An additional advantage of the present invention is the enabling of satellite systems at even higher frequencies that exhibit substantial rain attenuation since smaller spacecraft will be needed to achieve acceptable availability performance.

One more advantage of the present invention is a reduction in the cost of two way user terminals because the antenna's additional gain will reduce the required size of the uplink power amplifier.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a conceptual block diagram of a terminal configured to adapt to adverse transmission conditions caused by precipitation using a conventional two-piece architecture consisting of an outdoor unit (ODU) comprising the antenna with its reflector and feed as well as the reflector extensions and extension deployment mechanism of the present invention, and an indoor unit (IDU) comprising a controller (Terminal Control Processor), and the receive electronics (LNA and down converter) interconnected by a single coaxial cable that carries the all the required signals (rf, dc power and signaling) between them;

FIG. 2a is a front elevational diagrammatic view of the central reflector showing flared contacting extensions with full surface coverage around the full perimeter of the reflector;

FIG. 2b is a front elevational diagrammatic view of the central reflector showing spaced panel extensions for partial coverage around the perimeter of the reflector;

FIG. 2c is a front elevational diagrammatic view of the central reflector showing curved side panel extensions for coverage on two sides of the reflector.

### BEST MODE FOR CARRYING OUT THE INVENTION

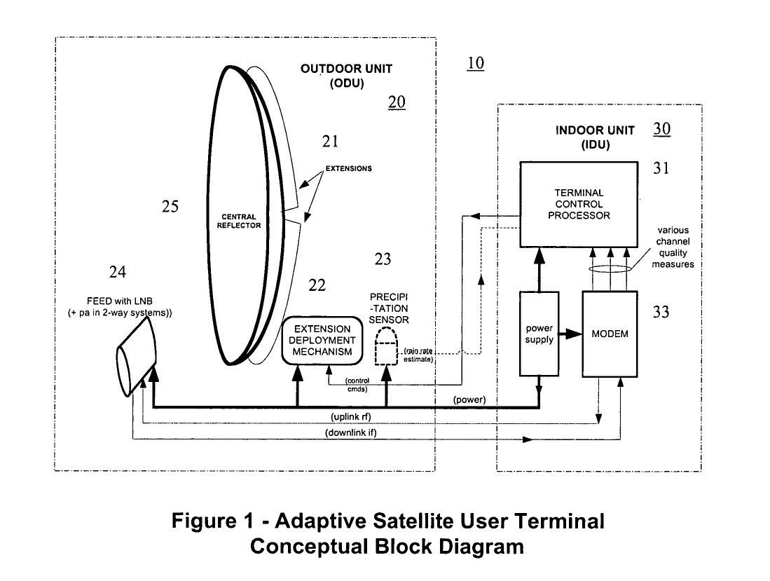

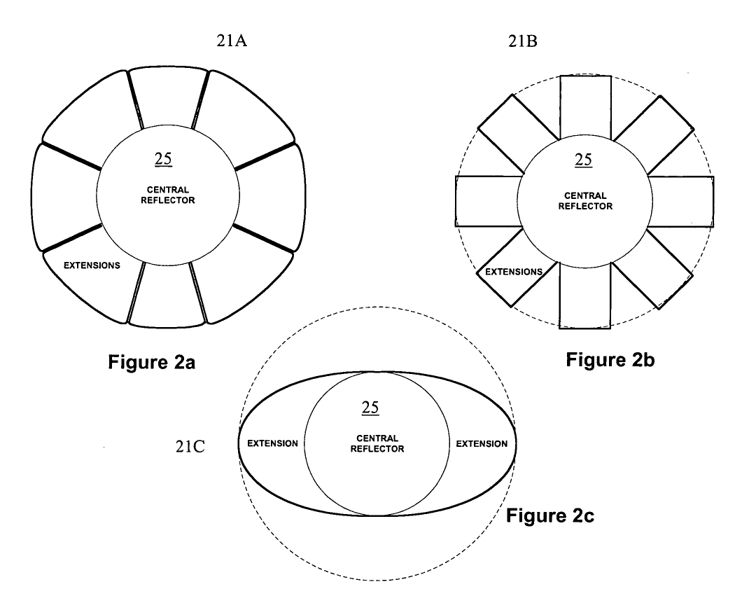

In FIGS. 1 and 2, an expansible terminal device 10 including a set of reflector extensions 21 is attached to the reflector 25 of a user terminal to extend a surface contour of a user terminal to modify its gain performance to accommodate changing operating conditions and maintain reception of satellite signals when signal quality is degraded.

A set of reflector extensions 21 and 21A-21C is movably attached to a standard size reflector 25 having a standard surface contour configured for receiving satellite signals. The set of reflector extensions 21 and 21A-21C is attached by a deployment means 22, labeled an extension deployment mechanism in FIG. 1, for extending and retracting the set of reflector extensions. The deployment means is adapted for extending the set of reflector extensions outside of a perimeter of a standard size reflector in a configuration which extends the projection of the surface contour of the reflector 25 as seen in FIGS. 2a-2c, to increase its effective capture area and hence its gain to enable reception of satellite signals when signal quality to a standard size reflector is degraded, such as during precipitation. The deployment means is further adapted for retracting the set of reflector extensions to return a standard size reflector and a standard surface contour when signal quality is satisfactory.

The set of reflector extensions 21 and 21A-21C comprise curved elements having metallic surface contours adapted for matching and extending the surface contour of a standard reflector 25 when the set of reflector extensions are extended. They may be fabricated of metal or a non-metallic material, such as nylon or plastic, that has been coated with a metallic material on an inside curved surface. The set of reflector extensions 21 are attached on a rear surface within an outer perimeter of a standard size reflector 25, as seen in FIG. 1.

In FIG. 2a, the set of reflector extensions 21A are configured in truncated pie-shaped sections (which may vary in size) contacting each other to form a complete annular ring around an outer perimeter of a standard size reflector 25 when the set of reflector extensions are extended for full coverage around the perimeter of a standard size reflector.

In FIG. 2b, the set of reflector extensions 21B are configured in radially extended rectangular tabs to form a broken annular ring around an outer perimeter of a standard size reflector 25 with a space between each adjacent pair of the set of reflector extensions when the set of reflector extensions are extended for partial coverage around the perimeter of a standard size reflector.

In FIG. 2c, the set of reflector extensions 21C are configured in half oval shapes to form curved opposing side panel extensions for coverage on at least two sides of a standard size reflector 25 when the set of reflector extensions are extended.

The deployment means 22, shown in FIG. 1 as a box labeled extension deployment mechanism, comprises a deployment means taken from the list of deployment means including electromechanical, hydraulic, pneumatic, inflation, driving gears, gear trains, levers, pulleys, and any combination of the list of deployment means.

The sensing means may comprise a modem 33 for transmitting received satellite signals to the control 31, labeled as a terminal control processor in FIG. 1, the modem adapted for demodulating and decoding the satellite signals to provide relevant information in the form of estimates of received signal-to-noise ratio and of pre- and post-decoding bit error rates.

The sensing means may further comprise a precipitation sensor 23 adapted for detecting precipitation and for supplying estimates of precipitation rate to the control 31.

The control 31 comprises a programmable control means for activating the deployment means 22, the control means adapted for receiving signals from the sensing means and further adapted for activating the deployment means to alternately extend and retract the set of reflector extensions based on quality of reception of satellite signals.

The control means 31 is adapted for setting threshold levels of signal quality for extension and retraction of the set of reflector extensions 21 and 21A-21C and setting minimum times between events and setting hysteresis and delays to prevent the terminal from cycling between extension and retraction during short intervals of change to make the device responsive without undue cycling.

When a reflector 25 is part of a two way system having a link to another user, the sensing means may further comprise a message detecting means, which could be a modem 33, for detecting a message from the other user at the other end of the link sensing a degraded transmission quality and requesting an increase in transmitted power to activate the deployment means 22 to extend the reflector extensions 21 and 21A-21C.

The expansible terminal device 10 may be fabricated with a standard size reflector and a set of reflector extensions in combination or it may be adapted for attaching to an existing standard size reflector.

In use, as presented in the conceptual block diagram of FIG. 1, an expansible terminal device 10 is configured to adapt to adverse transmission conditions caused by precipitation. The terminal shown uses a conventional two-piece architecture consisting of an outdoor unit (ODU) 20 and an indoor unit (IDU) 30. The outdoor unit comprises the antenna with its reflector 25 and feed 24, the receive electronics (LNA and down converter) and for a two way unit the transmit electronics (power amplifier). They are interconnected by a single coaxial cable that carries the all the required signals (rf, dc power and signaling) between them.

The central reflector can be any of several commonly used types: focus fed, offset fed, reflectarray, etc. On the rear of the reflector 25, a set of reflector extensions 21 is mounted. The reflector extensions 21A-21C are shapes such that when they are deployed as in FIGS. 2a-2c, they extend the projection of the required surface contour of the reflector 25 thus increasing its effective area and hence its gain.

The deployment means 22 extends and retracts the reflector extensions 21 and 21A-21C in response to control signals sent from the control 31, the terminal control processor, in the IDU 30.

The decision to extend or retract the extensions is made by the control 31, terminal control processor, based upon information from several sources or any combination of them. The modem 33 demodulates and decodes the received signal. It can provide relevant information in the form of estimates of the received signal-to-noise ratio and of pre- and post-decoding bit error rates. The optional precipitation sensor 23 detects precipitation to supply estimates of the precipitation rate. Using this data, the control 31 can determine the corresponding link attenuation and make a decision about deploying or retracting the extensions 21 and 21A-21C.

In some two way systems, the user at the other end of the link can sense degraded transmission quality and send messages requesting an increase in transmitted power. These messages can also be used as cues to operate the extensions.

In all cases, an appropriate control strategy based upon threshold levels for deployment and retraction, minimum times between events and other criteria is required to make this capability responsive but without undue cycling between states.

The most immediate use of the present invention would be in DTH video broadcast market because immediate improvements can be obtained in system capacity (by changing the code rate) or in expanded coverage area. Satellite direct-to-home broadcast and two-way Internet access services would be improved by the present invention. Users would include all current Ku-band DTH broadcasters, emerging Ka-band DTH broadcasters such as Eutelsat and Pegasus, Ka-band two-way wideband data services (could be applied directly to Astrolink, Wildblue, Spaceway and DVB-RCS. Future use would support the opening up of the higher commercial frequency bands to wideband multi-media broadcast and broadband 2-way services.

It is understood that the preceding description is given merely by way of illustration and not in limitation of the invention and that various modifications may be made thereto without departing from the spirit of the invention as claimed.

1. An expansible reflector device for a user terminal to extend a surface contour of a user terminal to modify its gain performance to accommodate changing operating conditions and maintain reception of satellite signals when signal quality is degraded, the device comprising:
a set of reflector extensions movably attached to a standard size reflector having a standard surface contour configured for receiving satellite signals, the set of reflector extensions attached to a standard size reflector by a deployment means for extending and retracting the set of reflector extensions, the deployment means adapted for extending the set of reflector extensions outside of a perimeter of a standard size reflector in a configuration which extends the projection of the surface contour of the reflector to increase its effective capture area and hence its gain to enable reception of satellite signals when signal quality to a standard size reflector is degraded and the deployment means further adapted for retracting the set of reflector extensions to return a standard size reflector to a standard surface contour when signal quality is satisfactory;
a sensing means for sensing quality of reception of satellite signals;
a programmable control means for activating the deployment means, the control means adapted for receiving signals from the sensing means and further adapted for activating the deployment means to alternately extend and retract the set of reflector extensions based on quality of reception of satellite signals.

2. The device of claim 1 wherein the control means is adapted for setting threshold levels of signal quality for extension and retraction of the set of reflector extensions and setting minimum times between events and setting hysteresis and delays to prevent the terminal from cycling between extension and retraction during short intervals of change to make the device responsive without undue cycling.

3. The device of claim 1 wherein the set of reflector extensions comprise curved elements having metallic surface contours adapted for matching and extending the surface contour of a standard reflector when the set of reflector extensions are extended.

4. The device of claim 3 wherein the set of reflector extensions are fabricated of metal.

5. The device of claim 3 wherein the set of reflector extensions are fabricated of a non-metallic material that has been coated with a metallic material on an inside curved surface.

6. The device of claim 5 wherein the set of reflector extensions are fabricated of nylon.

7. The device of claim 5 wherein the set of reflector extensions are fabricated of plastic.

8. The device of claim 1 wherein the deployment means comprises a deployment means taken from the list of deployment means including electro-mechanical, hydraulic, pneumatic, inflation, driving gears, gear trains, levers, pulleys, and any combination of the list of deployment means.

9. The device of claim 1 wherein the set of reflector extensions are attached on a rear surface within an outer perimeter of a standard size reflector.

10. The device of claim 1 wherein the set of reflector extensions are configured to form a complete annular ring around an outer perimeter of a standard size reflector when the set of reflector extensions are extended for full coverage around the perimeter of a standard size reflector.

11. The device of claim 1 wherein the set of reflector extensions are configured to form a broken annular ring around an outer perimeter of a standard size reflector with a space between each adjacent pair of the set of reflector extensions when the set of reflector extensions are extended for partial coverage around the perimeter of a standard size reflector.

12. The device of claim 1 wherein the set of reflector extensions are configured to form curved opposing side panel extensions for coverage on at least two sides of a standard size reflector when the set of reflector extensions are extended.

13. The device of claim 1 wherein the sensing means comprises a modem for transmitting received satellite signals to the control, the modem adapted for demodulating and decoding the satellite signals to provide relevant information in the form of estimates of received signal-to-noise ratio and of pre- and post-decoding bit error rates.

14. The device of claim 1 wherein the sensing means comprises a precipitation sensor adapted for detecting precipitation and for supplying estimates of precipitation rate to the control.

15. The device of claim 1 wherein a reflector is part of a two way system having a link to another user and the sensing means comprises a message detecting means for detecting a message from the other user at the other end of the link sensing a degraded transmission quality and requesting an increase in transmitted power.

16. The device of claim 1 wherein the device is fabricated with a standard size reflector and a set of reflector extensions in combination.

17. The device of claim 1 wherein the set of reflector extensions is adapted for attaching to an existing standard size reflector.
